(19) United States
(12) Patent Application Publication
(10) Pub. No.: US 2022/0361440 A1
(43) Pub. Date: Nov. 17, 2022

(54) PETCRUISING PET CARRIER-BACKPACK

(71) Applicant: Isaiah Lamar Gordon, III, San Francisco, CA (US)

(72) Inventor: Isaiah Lamar Gordon, III, San Francisco, CA (US)

(21) Appl. No.: 17/318,401

(22) Filed: May 12, 2021

(51) Int. Cl. A01K 1/02; A01K 1/00

(52) U.S. Cl. CPC A01K 1/0254; A01K 1/0064; A01K 1/029

(57) ABSTRACT

A pet carrier-backpack for carrying small to medium sized pets, with abundant space, sun protection, ventilation, support, and comfort, with the emphasis being the placement of air ventilation and the shade structure that offers maximum functionality. My soft sided pet carrier backpack is a portable home for the pet with an abundance of strategic ventilation and space, with a removable/expandible shade for the pets' sun protection. My invention functions as a car seat also and offers the option of choosing between two head holes so the pet can be zipped all the way in the pet carrier and enclosed, laying down, or having its head out of the backpack, while its body is completely enclosed. There is a removable-sturdy, fur bed that detaches from the bag to allow your pet to lay on it anywhere you place it. The circular air vents on the front face of the pet carrier as well as the air vents on the left and right sides of the invention, create discrete as well as non-discrete usage options for experience, while maximizing air flow.

### BACKGROUND OF THE INVENTION

Problem Solved: There is a lack of sun protection, versatility, discreteness, ventilation, and comfort in the pet carrier backpacks offered on the market. There is also a lack of autonomy with pets being able to have their heads completely enclosed in the backpack or peering out a head hole. Other pet carrier backpacks do not offer discreteness in design, while maximizing comfort and ventilation. They also do not lay down to become a comfortable and ventilated den while the bag is zipped closed, also while the bag is completely opened with the pet exposed. No other pet carrier-backpack has a shade structure to shield the pet from the sun. Our shade structure is removeable and the shade expands for situational needs and fits into the bags' pockets.

Other soft sided Pet carrier backpacks do not accommodate for pets to be completely enclosed in the pet carrier backpack with sufficient discreteness, ventilation, space, and comfort, with the option of the pets' head being inside or outside of the carrier. The 9 to 11 circular vents surrounding the front façade of the pet carrier offer a discrete ventilation system that is a new and unseen edition to the pet carrier market. The ventilation system on the two outer facing sides of the bag offer discrete, versatile and functional air flow for the pet.

The Petcruising pet carrier backpack is a portable home for the pet, with an abundance of ventilation and interior space, as well as the option of choosing between two head holes for the pet to be zipped all the way in the bag and enclosed, laying down enclosed body-exposed head/no visible pet exposure, or having its head out of top head hole while its body is completely enclosed. There is also a removable, sturdy, fur bed that detaches from the bag to allow your pet to lay on it anywhere you place it.

There is a lack of space, ventilation, and comfort in the pet carrier backpacks offered. There is also a lack of autonomy with pets being able to have their heads completely enclosed in the backpack or peering out a head hole. Other pet carrier backpacks do not offer sun protection and discreteness of design, while maximizing comfort. They also do not lay down to become a comfortable and ventilated den for the pet. The invention claimed here solves this problem.

The PetCruisin' Pet Carrier-Backpack has two discrete zip up head holes. The first head hole is on the front face of the bag that allows for the pet to be completely enclosed in the bag when zipped up, but still able to view thru the netting. The pet can also have its head peering out. The second head hole is placed on the bottom of the bags side. This allows for the pet to lay down with its head out. This bottom head hole, with its zipped netting and cover also provide discrete and non-discrete air flow as well as viewing for the pet. The two head holes and 9 or 11 circular ventilation holes/grommets offer an abundance of ventilation that is highly needed, with the option to cover the bottom head hole for maximum discreteness. The PetCruisin' Pet Carrier looks like a regular backpack, letting the pet and human interact with the world in an incognito fashion. It also functions as a pet den when laying down for the pet to sleep comfortably with sufficient space and ventilation.

The claimed invention differs from what currently exists. There are no other soft sided pet carrier backpacks with two zip up head holes with reflective piping for night visibility, that allow for the pet to be completely enclosed in the bag with an abundance of space, safety, and ventilation. The shade structure we offer to shield the pet from the sun is a feature not offered currently in the market. We are the pioneers.

This invention is an improvement on what currently exists. There are no other soft sided pet carrier backpacks with two zip up head holes with reflective piping for night visibility, that allow for the pet to be completely enclosed in the bag with an abundance of space, safety, and strategic ventilation. Our circular vents on the front façade of the bag offer discrete ventilation that hasn't been introduced into the pet carrier market before.

In this market segment there is not enough space, ventilation, and comfort for a pet in a soft sided pet carrier backpack, while offering discreteness and style to the human and pet.

My soft sided pet carrier backpack is a portable home for the pet, with an abundance of strategic ventilation and space. We offer the option of choosing between two head holes for when the pet is zipped all the way in the bag and enclosed. The first option is the pet laying down all while its body is completely enclosed in the bag. The second option is the pet sitting upright in the bag, using the ventilation and viewing nets on the top part of the bag. There is also a removable, sturdy, fur bed that detaches from the bag to allow your pet to lay on it anywhere you place it.

### The Invention in Full Includes

1. Zip up head holes that roll down or tuck in a pocket.

2. Zipped back entrance. Abundant Pocket Space/Expandible side pockets. Interchangeable sides for country specific.

3. Grommets/small circular holes for incognito ventilation.

4. Interior safety buckles for pet's harness.

5. Interior removable pillow.

6. Interior removable pillow with plastic inserts and fur cover.

7. Durable/Comfortable carrying handle, Seatbelt strap, waist strap pocket, and waist strap, with excess strap holder pockets.

8. Removable waist strap pocket with Velcro.

9. Chest strap slider, ergonomic shoulder straps, back padding.

10. A removable and expandible shade structure to shield the pet from the sun.

11. Use of sustainable materials to show love to our mother earth.

### Claimed Features with Corresponding Claim Number for Reference

1. Ventilation on the front façade of the bag, in the form of a pet head and its transparent netting as well as nine or eleven circular holes/grommets.

2. Ventilation on the left side of the bag in the form of netting with an optional cover.

3. Ventilation on the right side of bag in the form of netting with an optional cover.

4. Removable-expandible shade to shield the pet from the sun.

5. Automobile seatbelt strap that secures the pet carrier to the car seat to prevent injury to the pet.

6. Reflective piping for night visibility on the front of the bag, including the reflective piping surrounding the main head hole, the reflective piping on the sides of the front façade of the bag, and the reflective piping on the left and right sides.

### DETAILED DESCRIPTION OF THE INVENTION

The placement of the top head hole is in the top-middle-center of the bags front facing facade. The top head hole is covered with see-through zipper-secured netting for the pet to see out while sitting in an upright position. The netting can roll down and is secured with two clipped straps. The straps are secured by two small slits, 1 inch, that are interior pockets, one on each of the bottom of the corners of the head hole (outer bag). The netting can also fold into the interior of the bag (pocket on interior bag below head hole) for fast stowage.

The bottom pet head hole is on the left side of the bag. It has the same zipped netting as the top-front head hole but with an addition of a cover for privacy and wind protection. The cover has a fully closed option, and a partially opened option, depending on preference and weather. The head hole netting and cover is secured in the same manner as the top head hole, with a pocket on the interior of the bags side for fast stowage of the netting and its cover. Also, the netting and cover can roll down and is secured by 2 clipped straps which are secured in the same manner as the top head hole. The bottom left head hole and the bottom-right side vent on the opposite side of the bag facilitate trust between the pet and the carrier because there is sufficient ventilation and outer viewing capability at the bottom-inside of the bag. There is a cover for the bottom head hole netting (zero exposure), and the cover has a flap that folds up or down allowing for partial exposure/view or no exposure/view. The cover can be folded down into a pocket or rolled down and secured by clips/straps.

The ventilation on the top left side of the pet carrier allows for the pet to sit in an upright position, with its head facing the left side, being able to see outside the bag through the netting. This rectangular vent spanning the width of the bags top-side does not have a cover, as it is necessary to stay open for air flow purposes. Below this vent is a pocket that spans from the bottom of the top-left vent to the bottom-left head hole. This pocket spans the width of the left side of the bag. This pocket is accessed by the left side main zipper, it is made to stretch outwards for fitting maximum personal items, and it is the only pocket that is accessed by the left-side main zipper.

The grommets/circular vents offer discrete-abundant ventilation. The main entrance is made specific so the pet can be placed inside without a fight from the pet. Also, so the back of the bag can unzip completely to its bottom, and can fold down onto the ground/surface, creating an enlarged and exposed bed.

The right side of the pet carrier (for explanation purposes, depending on U.S or European Models, the sides will be interchangeable for market regularity, so the pet is always facing the driver of the car while in the front passenger seat of the car. The right-sides largest pocket is the main pocket and offers abundant space for belongings. This pocket expands outward with a stretch material and is padded on the pet carrier interior. Inside the right-side main pocket there is a zippered pocket to secure smaller valuables such as a phone, credit cards, cash, and jewelry. On the outside of the main right-side pocket is the second right side pocket that is zipped open/closed. This pocket is for easy access and storage. It spans ¾ the height, and the full width of the main side pocket, while protruding outwards 1 inch. On the outside of this pocket is a non-see thru stretch pocket, free standing-no closure, for easy stowage, spanning the entire width of the second right side zippered pocket, and its height discontinues at the top zipper for the second right side pocket.

All seams are sewn inside of the bag and the interior of the bag is lined with ⅛ inch padding for pet comfort.

The adjustable interior straps allow for the pet to be secured inside of the bag, so not being allowed to exit the bag. The interior pillow offers maximum, soft comfort for the pet, and is secured by plastic lining material so urine or other liquids do not seep into padding. The Hard plastic insert is a platform for the back lining part of the padding creates structure for the bag and is a platform for the pet to rest on. The seat belt strap allows for a car's seat belt to go through the strap and back of carrier, and the pet carrier is secured to the car seat. The pet should always be secured by the interior security straps to prevent jumping or falling out of the pet carrier. The waist strap is removable for preference and slides through the waist strap pocket and is secured inside of the waist strap pocket with Velcro. The removable waist strap offers waist and back support and can be removed and placed into one of the bags pockets when it is not needed. The buckle slit pockets throughout offer functionality by keeping the buckle straps from dangling. The shoulder straps are ergonomic for maximum comfort and support for the neck and back, as is the padding on the back of the bag. The chest strap slider allows the chest strap to adjust to the pet owners body positioning. The handle is attached top of the back of the bag and allows for sturdy and comfortable hand carrying of the carrier. We are producing a pet carrier that has structure and stability but is also soft and plush for the pet. There is a sturdy wired piping that lines the main entrance zipper in full, on both the back fold down side of the entrance zipper, and the pet carrier side entrance zipper. This creates stability for the bag to stand up in a sturdy posture when placed on a surface. Traditional and new-age cut-and-sew methods are to be used for manufacturing with heavy duty machinery. Petcruising is made with highly durable and sustainable materials for longevity, earth love, and pet safety.

### How to Use the Invention

You would 1. Unzip the top head hole and roll it down so it is secured with the small head hole buckle straps. 2.Then you unzip the entrance which is the entire back of the bag. 3. Pick up your pet and place them into the pet carrier butt first. 4. You then secure your pets harness being worn, with the interior strap and swivel hook, so the pet is secure to the bag. 5. You can either close the head hole or keep it open at this point. 6. Zip the bag up, making sure the two zippers are secured at the bottom of the bag and locked. You can lay the bag down on its back to function as a pet dwelling/enclosed bed, or you can put the shoulder straps across shoulders as you would a regular backpack and fasten the chest strap clip for support. If the carrier is being used in the car, you will follow steps 1-6 and then place the carrier with pet inside into the car seat and place the seat belt through the seat belt strap on the back of bag, then fasten the seat belt secure. 7. One can also fasten the chest strap clip, and then put the carrier on the stomach side of the pet's owner, so to be worn with the bag on facing forward. 8. To shield from the pet from the sun's rays you would take the two extendable poles that are attached to the shade and place them in the cylindrical pockets on the upper sides of the bag. The poles will latch in place automatically. The shade can extend vertically and horizontally.

Additionally: You can use the carrier to carry many other items of your desire, not just pets, given that items are sized to fit in the bag and its outer pockets.

### DESCRIPTION OF EXISTING SIMILAR PRODUCT UTILITY PATENTS

1. Folding Pet Carrier|Patent #US 2019/0313597 A1|Published Oct. 17, 2019|application Ser. No. 16/183,739|Chen

This pet carrier backpack has 4 wheels to roll it on the ground, small side pockets, and large ventilation netting panels on the two top sides, and one on the top of the other on the front of the pet carriers face. This pet carrier is hard-sided and doesn't offer extreme comfort for the pet and the human carrying. The ventilation on this invention is too large, offering no discreteness for the pet carrying experience. The bottom of this invention also protrudes into the back of the person wearing it, causing back problems. The hardness of the bottom of this invention will also cause issues for the pet, especially pets of older age. There is also no shade structure, yet alone a removable and expandible option on this existing invention. My invention fixes these problems and offers a more modern and discrete style and ventilation system, while offering a removable/expandible shade structure for sun protection for the pet.

2. Pet Carrier|Patent #US 2017/0172102 A1|Published Jun. 22, 2017|application Ser. No. 14/972,220|Rivera

This invention is a pet carrier backpack that has small side pockets and allows the pet to sit in the backpack with it's head and neck protruding from the back. This pet carrier only partially covers the pet and does not allow the pets head to be secured in the backpack completely. Hence this invention would not be used for airline travel. This pet carrier is for smaller pets under 20 pounds and isn't highly functional for situational needs.

3. Pet Carrier|Patent #US 2008/0072838 A1|Published Mar. 27, 2008|application Ser. No. 11/512,672|Beach/Bishop

A pet carrier that includes a lateral support panel sized and shaped to fit beneath the abdomen of a pet. This includes a carrying strap that is placed over the shoulder, chest, and back of the human. The pet can not be enclosed inside of the pet carrier, and the pet also has its 4 limbs always dangling from the pet carrier. This pet carrier is not highly functional for situational needs and does not provide discreteness on any level. While the idea of the sling is a good one, there is no versatility for daily pet and human experiences. In this patented product there is no safety options for car rides, as the pet is completely exposed to the elements. My pet carrier invention is an all-around upgrade to this said patent. My invention offers the pet abundant protection on many levels as well providing high functionality and style.

### BRIEF DESCRIPTION OF DRAWINGS

FIG. 1 (Corresponds with Claim #1) in general is the ventilation on the front facade of the bag, in the form of a pet head hole and its transparent netting as well as nine or eleven circular holes/grommets. FIG. 1a. View 1 is the eleven circular vents surrounding the front pocket and front facing head hole for discrete and abundant ventilation for the pet. In addition, there may be 9 circular vents on the smaller versions. FIG. 1b. View 1 shows the front head hole netting that zips down for pet head exposure. There is no cover for this vent. The netting has two options for stowage, rolled down and secured by straps with clips, or folded into the interior pocket. FIG. 1c. View 1 shows two pockets under the front head hole for holding the straps with clips that secure the rolled down front head hole netting. In FIG. 1d.—View 2, the interior pocket is used for easy stowage of the main front pet head hole netting.

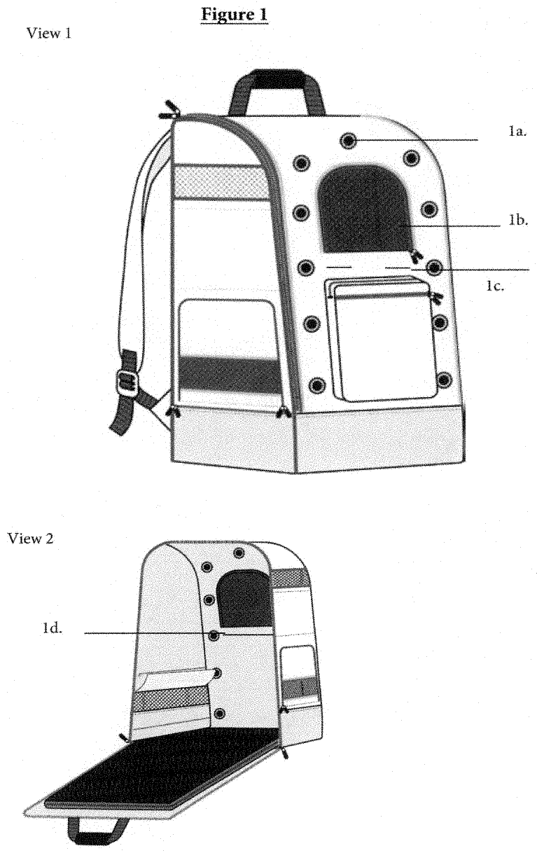

FIG. 2 (Corresponds with Claim #2) in general is the ventilation on the left side of the bag in the form of netting with an optional cover. FIG. 2a. discloses a rectangular netting that spans the width of the top left side of the pet carrier. This provides discrete airflow and viewability for the pet. FIG. 2b. is the netting cover window that covers the bottom head hole ventilation netting fully, partially, with the option of having the ventilation netting cover completely folded or rolled down for full exposure. FIG. 2c. is the bottom head hole ventilation netting that is zippered close or open, and when open, it can fold into the pocket below the head hole or it can roll down with the netting cover and secure with clips attached to small straps. FIG. 2d. is the pocket slit that is used for stowing bottom head hole netting and its cover. FIG. 2e. is the opening for the bottom head hole, pictured as opened and exposed. FIG. 2f. is the ventilation netting and the netting cover, which is pictured with the netting and netting cover zipped open rolled down. FIG. 2g. is the interior small slit pocket for option of folding netting into directed toward inside of bag. FIG. 2h. is an interior of bag pocket that is situated between inside material and exterior material directly below the bottom head hole. FIG. 2i. is the bottom head hole cover's flap. It is shown as open, with the ventilation netting partially exposed. FIG. 2j. is the bottom head hole cover's interior view, showing the head hole cover's partial view flap that velcro's to the top of the flap's opening, to partially expose the ventilation netting. FIG. 2k. is the bottom head hole cover's view flap, and is shown as closed with the ventilation netting shown as completely unexposed. This is for cold weather and high wind protection for the pet.

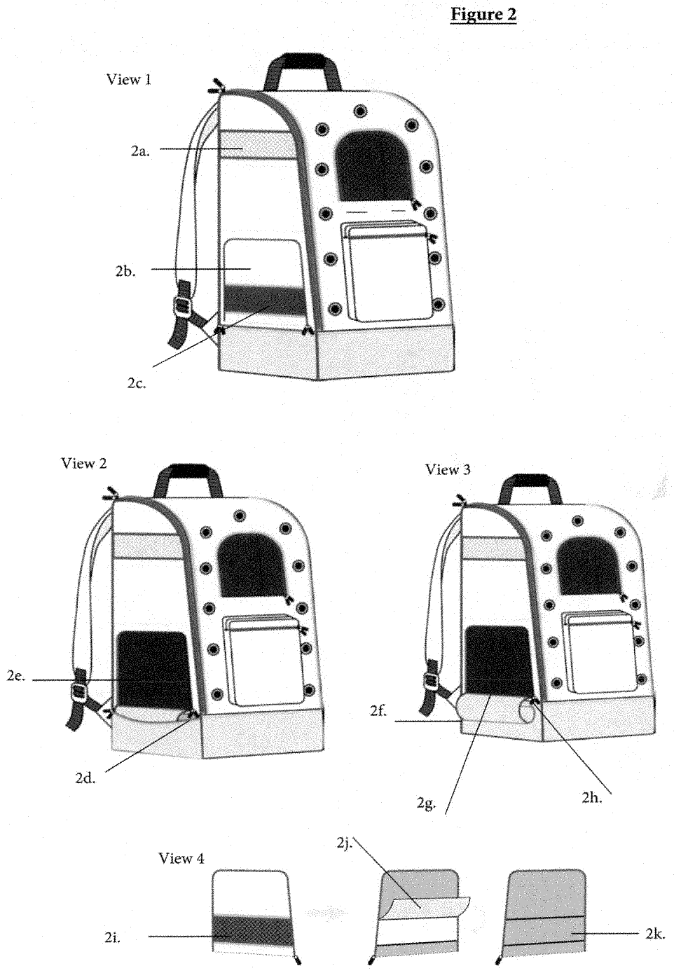

FIG. 3 (Corresponds with Claim #3) is the ventilation on the right side of bag in the form of netting with an optional interior vent cover. FIG. 3a. illustrates the right side's largest pocket. It is the main pocket and offers abundant space for belongings. This pocket expands outward using a stretch material and is padded on the pet carrier interior so items in the pocket don't protrude on the interior of the pet carrier. FIG. 3b. shows the pocket outside of the main right-side pocket. It is the second right side pocket, and is zipped open/closed. This pocket is for easy access and storage. It spans ¾ the height of the main right-side pocket, and the full width of the main side pocket, while protruding outwards 1 inch. FIG. 3c. is a non-see thru stretch pocket, layering the right side zipped-second pocket, free standing-stretch-no closure, for easy stowage, spanning the entire width of the second right side zippered pocket, and its height discontinues at the top zipper for the second right side pocket. FIG. 3d. illustrates the right side's ventilation netting that spans the entire width of the side of pet carrier. It is lined with reflective piping on the entire top and bottom of the netting. This ventilation netting has an interior netting cover for cold weather and high wind protection. FIG. 3e. shows the interior view of the main right-side pocket. Padding lines the interior facing side of this pocket. FIG. 3f. is the interior view of the main right-side pocket. Showing the exterior facing side of the interior of the pocket, with a slit vertically in the middle of the pocket for a stretch effect. FIG. 3g. is the interior view of the right side of bag's ventilation cover-stowage pocket when the netting is exposed. FIG. 3h. is an interior view of the pocket that spans the width of the right-side ventilation, and is a pocket used to conceal the netting ventilation to unexposed. Made for cold weather or high wind.

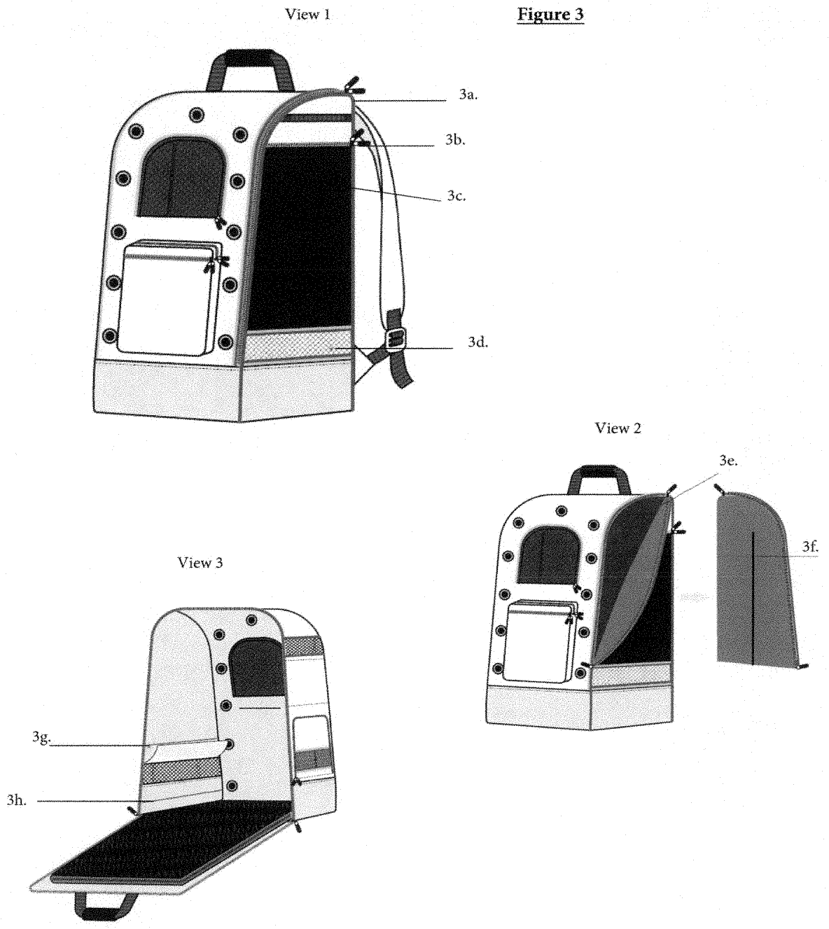

FIG. 4 (Corresponds with Claim #4) is the removable-expandible shade structure to shield the pet from the sun. FIG. 4a. is the front of the shade platform concealing shade expansion platform underneath. FIG. 4b. is the top of shade platform, and FIG. 4c. is the extender pole that lengthens 3 inches, is lockable, and is used for shade support. Duplicate on opposite side. FIG. 4d. shows the shade pole that is attached to the shade platform and extender pole. This is one of the two main poles and are lockable for-steadiness. This pole slides into the shade pole pocket and secures with a button protruding from an opening at the bottom side of the shade pole pocket. This is the exact same on the opposite side of the pet carrier/shade structure. FIG. 4e. is the shade pole pocket that holds the two shade poles on the opposite sides of the pet carrier. This pocket is securing-holding the shade poles securely with minimal movement. Hole on the bottom-side of the pocket to enable the shade pole button to protrude from and lock in place. FIG. 4f. shows the concealing of the side shade platform extenders that extends four inches outward on both the left-right and front sides. There are three shade platform extenders, one on the right-left- and front of the underneath portion of the main shade platform. They are concealed by pockets underneath the shade structure and extend out and lock in place.

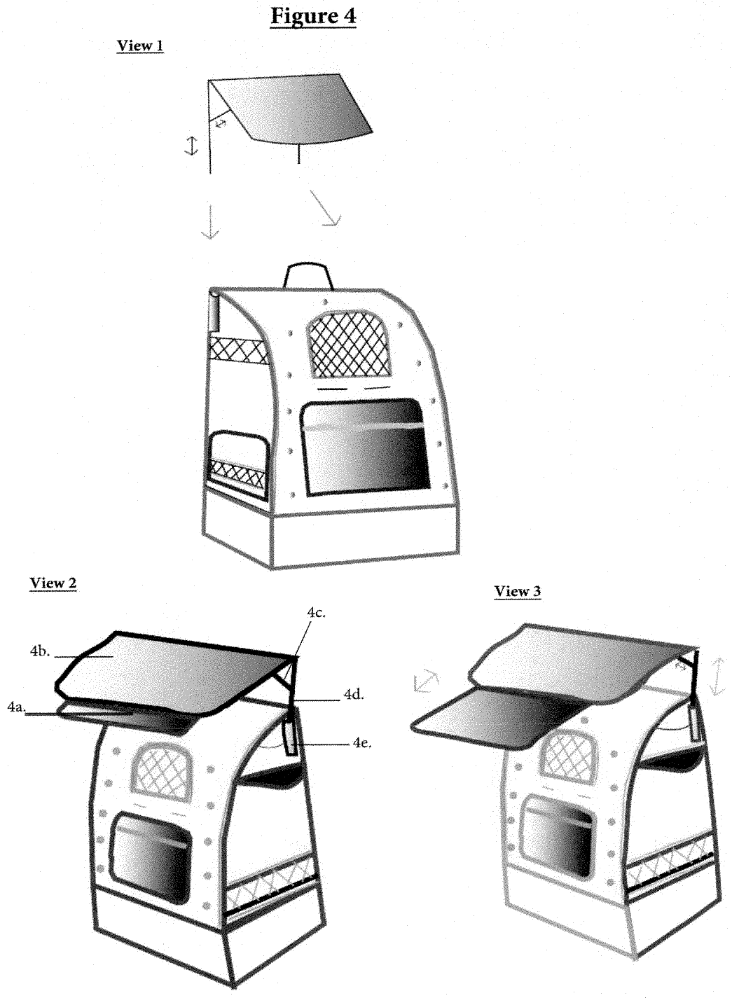

FIG. 5 (Corresponds with Claim #5) in general is the automobile seatbelt strap that secures the pet carrier to the car seat to prevent injury to the pet. FIG. 5a. is the placement of the seatbelt strap for secure pet car rides. FIG. 5b. is where the seatbelt strap is sewn down to the bag in two places, at the top-most inch of the strap and the bottom most inch of the strap. FIG. 5b. is shows where the car seatbelt is placed through the middle of the seatbelt strap on the back of the pet-carrier, in-between the two main back pads, and above the bottom back padding. This secures the pet carrier to the car seat, and the pet should be secured with the straps inside of the pet carrier for further safety.

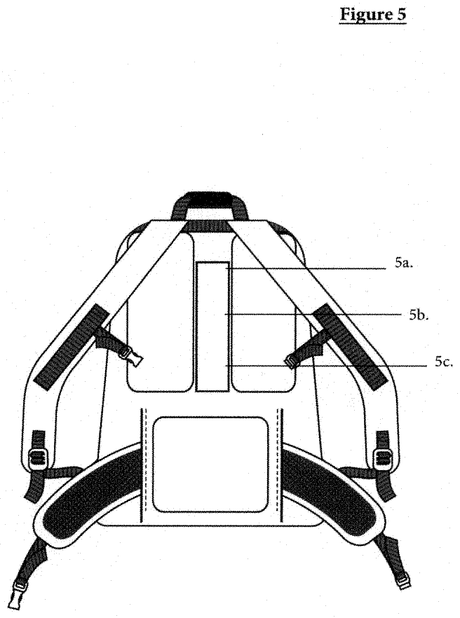

FIG. 6 (Corresponds with Claim #6) in general is the reflective piping for night visibility. Located on the front of the bag, including the reflective piping surrounding the main head hole, the reflective piping on the sides of the front façade of the bag, and the reflective piping on the left and right sides. FIG. 6a. is the reflective piping that is lined parallel with the side head hole's cover view-flap. This is the bottom portion of the piping on the cover's view-flap. FIG. 6b. is the reflective piping that is lined parallel with the side head hole cover's view-flap. This is the top portion of the piping on the cover's view-flap. FIG. 6c. is the reflective piping strip that begins at the top of the bag, parallel to the left side's main zipper, and ends at the bottom platform material where the zipper ends. The right side's pockets all begin atop this piping. FIG. 6d. is the reflective piping strip that surrounds the front main head hole zipper. FIG. 6e. is the reflective piping strip that begins at the top of the bag, parallel to the right side's main zipper, and ends at the bottom platform material where the zipper ends. FIG. 6f. is the reflective piping strip that runs parallel to the top of the right side's bottom vent. This runs the length of the bags side width. FIG. 6g. is the reflective piping strip that runs parallel to the bottom of the right side's bottom vent. This runs the length of the bags side width.

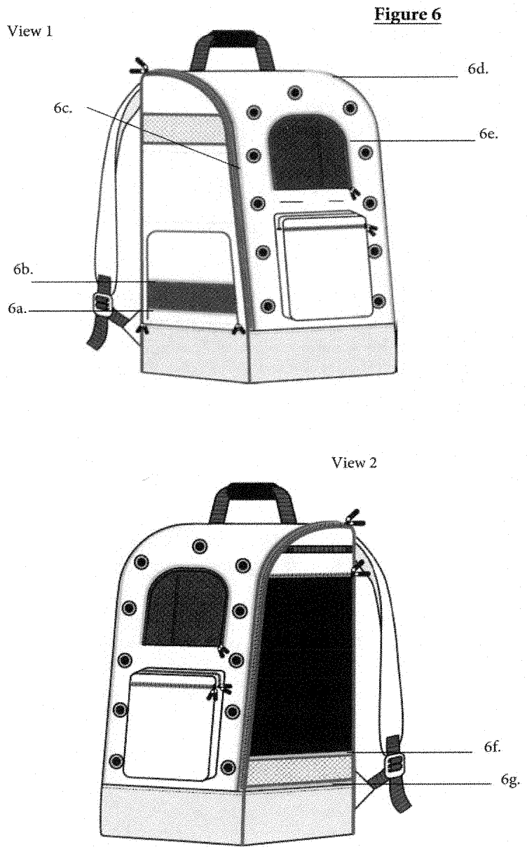

1: Ventilation on the front façade of the bag, in the form of a pet head hole and its transparent netting as well as nine or eleven circular holes/grommets.
1a. Eleven circular vents surrounding the front pocket and front facing head hole for discrete and abundant ventilation for the pet. In addition, there may be 9 circular vents on the smaller versions.
1b. Front head hole netting that zips down for pet head exposure. There is no cover for this vent. The netting had two options for stowage, rolled down and secured by straps with clips, or folded into the interior pocket.
1c. Two pockets under the front head hole for holding the straps with clips that secure the rolled down front head hole netting.
1d. Interior pocket for easy stowage of the main front pet head hole netting.

2: Ventilation on the left side of the bag in the form of netting with an optional cover.
2a. A rectangular netting that spans the width of the top left side of the pet carrier, that provides discrete airflow and viewability for the pet.
2b. Netting cover window that covers the bottom head hole ventilation netting fully, partially, and also the ventilation netting cover can completely fold or roll down for full exposure.
2c. Bottom head hole ventilation netting that is zippered close or open, and when open can fold into the pocket below the head hole or it can roll down with the netting cover and secure with clips attached to small straps.
2d. Pocket slit used for stowing bottom head hole netting and its cover.
2e. Opening for the bottom head hole, pictured as opened and exposed.
2f. Ventilation netting and the netting cover pictured with the netting and netting cover zipped open rolled down.
2g. Interior small slit pocket for option of folding netting into directed toward inside of bag.
2h. Pocket situated between interior material and exterior material directly below the bottom head hole.
2i. Bottom head hole cover's flap is shown as open, with the ventilation netting partially exposed.
2j. Bottom head hole cover's interior view, showing the head hole cover's partial view flap that velcro's to the top of the cover flap opening, to partially expose the ventilation netting.
2k. Bottom head hole cover's view flap is shown as closed and the ventilation netting is completely unexposed. This is for cold weather and high wind protection for the pet.

3: Ventilation on the right side of bag in the form of netting with an optional interior vent cover.
3a. Right side largest pocket is the main pocket and offers abundant space for belongings. This pocket expands outward using a stretch material and is padded on the pet carrier interior so items in the pocket don't protrude on the interior of the pet carrier.
3b. On the outside of the main right-side pocket is the second right side pocket that is zipped open/closed. This pocket is for easy access and storage. It spans ¾ the height of the main right-side pocket, and the full width of the main side pocket, while protruding outwards 1 inch.
3c. Non-see thru stretch pocket layering the right side second pocket that is zippered, free standing-stretch-no closure, for easy stowage, spanning the entire width of the second right side zippered pocket, and its height discontinues at the top zipper for the second right side pocket.
3d. Right side's ventilation netting that spans the entire width of the side of pet carrier. It is lined with reflective piping on the entire top and bottom of the netting. This ventilation netting has an interior netting cover for cold weather and high wind protection.
3e. Interior view of the main right-side pocket. Padding lines the interior facing side of pocket.
3f. Interior view of the main right-side pocket. Showing the exterior facing side of the interior of the pocket, with a slit vertically in the middle of the pocket for a stretch effect.
3g. Interior view of interior pocket that spans the width of the top of the right-side ventilation netting, to conceal netting cover when netting is exposed.
3h. Interior view of interior pocket that spans the width of the bottom of the right-side ventilation netting, to conceal the netting ventilation during cold weather or high wind.

4: Removable-expandible shade to shield the pet from the sun.
4a. Front of shade platform concealing shade expansion platform underneath.
4b. Top of shade platform.
4c. Extender pole that lengthens 3 inches, is lockable, and is used for shade support. Duplicate on opposite side.
4d. Shade Pole that is attached to the shade platform and extender pole. This is one of the two main poles and are lockable for steadiness. This pole slides into the shade pole pocket and secures with a button protruding from an opening at the bottom side of the shade pole pocket. This is the exact same on the opposite side of the pet carrier/shade structure.
4e. Shade Pole Pocket that holds the two shade poles on the opposite sides of the pet carrier. This pocket is securing-holding the shade poles securely with minimal movement. Hole on the bottom-side of the pocket to enable the shade pole button to protrude from and lock in place.
4f. Concealing the side shade platform extenders that extends four inches outward on both the left-right and front sides. There are three shade platform extenders, one on the right-left- and front of the underneath portion of the main shade platform. They are concealed by pockets underneath the shade structure and extend out and lock in place.

5: Automobile seatbelt strap that secures the pet carrier to the car seat to prevent injury to the pet.
5a. Placement of seatbelt strap for secure pet car rides.
5b. The seatbelt strap is sewn down to the bag in two places, at the top-most inch of the strap and the bottom most inch of the strap.
5c. The car seatbelt is placed through the middle of the seatbelt strap on the back of the pet-carrier, in-between the two main back pads, and above the bottom back padding. This secures the pet carrier to the car seat, and the pet should be secured with the straps inside of the pet carrier for further safety.

6: Reflective piping for night visibility on the front of the bag, including the reflective piping surrounding the main head hole, the reflective piping on the sides of the front facade of the bag, and the reflective piping on the left and right sides.
6a. Reflective piping is lined parallel with the side head hole's cover view-flap. This is the bottom portion of the piping on the cover's view-flap.
6b. Reflective piping is lined parallel with the side head hole cover's view-flap. This is the top portion of the piping on the cover's view-flap.
6c. Reflective piping strip that begins at the top of the bag, parallel to the left side's main zipper, and ends at the bottom platform material where the zipper ends. The right side's pockets all begin atop this piping.
6d. Reflective piping strip that surrounds the front main head hole zipper.
6e. Reflective piping strip that begins at the top of the bag, parallel to the right side's main zipper, and ends at the bottom platform material where the zipper ends.
6f. Reflective piping strip that runs parallel to the top of the right side's bottom vent. This runs the length of the bags side width.
6g. Reflective piping strip that runs parallel to the bottom of the right side's bottom vent. This runs the length of the bags side width.
Traditional and new-age cut-and-sew methods are to be used for manufacturing with heavy duty machinery. Petcruising is made with highly durable and sustainable materials for longevity, earth love, and pet safety.
